(19) United States
(12) Patent Application Publication
(10) Pub. No.: US 2020/0238625 A1
(43) Pub. Date: Jul. 30, 2020

(54) 3D PRINTER

(71) Applicants: OREGON STATE UNIVERSITY, Corvallis, OR (US); HEWLETT-PACKARD DEVELOPMENT COMPANY, L.P., Spring, TX (US)

(72) Inventors: David A Champion, Lebanon, OR (US); Daniel Mosher, Corvallis, OR (US); Brian Bay, Corvallis, OR (US)

(21) Appl. No.: 16/608,382

(22) PCT Filed: Oct. 16, 2017
(86) PCT No.: PCT/US2017/056761

§ 371 Date: Oct. 25, 2019

(51) Int. Cl. B29C 64/393; B33Y 50/02; B33Y 30/00

(52) U.S. Cl. CPC B29C 64/393; B33Y 10/00; B33Y 30/00; B33Y 50/02

(57) ABSTRACT

An example method includes forming a layer of build material on a build platform of a 3-D printer and correlating X-Y position data and stereoscopic Z-position data for particles of the build material in the layer of build material that are determined to exceed a threshold criteria based on a measure attribute.

### BACKGROUND

Additive manufacturing systems may be used to produce three-dimensional (“3D”) objects. In some examples, the 3D objects are produced in layers using build material.

### BRIEF DESCRIPTION OF THE DRAWINGS

FIGS. 1A-1E are example schematic illustrations of an example 3D printer and FIGS. 1F-1H are examples of example image data obtained from the example 3D printer in accordance with the teachings of this disclosure.

FIG. 2 is a schematic illustration of the example build controller of FIG. 1 in accordance with the teachings of this disclosure.

FIGS. 3A-3B are example top views of an example layer of build material applied by the example 3D printer of FIGS. 1A-1H during an example build process in accordance with the teachings of this disclosure.

FIG. 4 is an example sectional-view of an example 3D object during a build process of the example 3D printer of FIGS. 1A-1H in accordance with the teachings of this disclosure.

FIGS. 5A-5B are example sectional-views of an example 3D object during a build process of the example 3D printer of FIGS. 1A-1H in accordance with the teachings of this disclosure showing differences between an idealized representation of a particle Z-height, assuming a uniform layer thickness, and an actual particle Z-height relative to actual layer thicknesses.

FIG. 6A shows an example top view of an example discretized layer of build material applied by the example 3D printer of FIGS. 1A-1H during an example build process, and an example coarse texture analysis to identify anomalies in regions of the discretized layer of build material, in accordance with the teachings of this disclosure.

FIG. 6B shows, further to FIG. 6A, illustrates an example focused analysis of the identified anomalies in regions of the discretized layer of build material, in accordance with the teachings of this disclosure.

FIGS. 7A-7B are flowcharts representative of machine readable instructions that may be executed to implement the example build controller of FIG. 2.

FIG. 8 is a processor platform to execute the instructions of FIGS. 7A-7B to implement the example build controller of FIG. 2.

The figures are not to scale. Wherever possible, the same reference numbers will be used throughout the drawing(s) and accompanying written description to refer to the same or like parts. While the drawings illustrate examples of printers and associated build controllers, other examples may be employed to implement the examples disclosed herein.

### DETAILED DESCRIPTION

The examples disclosed herein relate to systems and methods for using stereo vision to resolve attributes of individual particles of a build material (e.g., size, color, x-position, y-position, z-position, etc.), layer by layer, during an additive manufacturing process. In some examples, the build material particles include powders, powder-like materials and/or short fibers of material (e.g., short fibers formed by cutting a long strand or thread of a material into shorter segments, etc.) formed from plastic, ceramic, or metal. In some examples, the build material particles include nylon powder, glass-filled nylon powder, aluminum-filled nylon powder, acrylonitrile butadiene styrene (ABS) powder, polymethyl methacrylate powder, stainless steel powder, titanium powder, aluminum powder, cobalt chrome powder, steel powder, copper powder, a composite material having a plurality of materials (e.g., a combination of powders of different materials, a combination of a powder material or powder-like material with a fiber material, etc.). In some examples, the 3D print material may include coatings (e.g., titanium dioxide) or fillers to alter one or more characteristics and/or behaviors of the 3D print material (e.g., coefficient of friction, selectivity, melt viscosity, melting point, powder flow, moisture absorption, etc.).

In some examples, particular particles of interest (e.g., particles above a dimensional threshold, particles having a particular shape, etc.) are flagged and mapped to the layer to permit evaluation of the flagged particles relative to critical build structures to determine whether a layer of build material applied during the additive manufacturing process is acceptable (e.g., a flagged particle lies in a non-critical area) or whether corrective actions are required to be implemented to the applied layer of build material to ensure that the 3D object produced by the additive manufacturing process satisfies predetermined build criteria for the 3D object.

In some examples, corrective actions may include changing a build characteristic of the additive manufacturing process, such as redistributing the build material on the work area to reduce topographical variances, changing the z-position of the work area to change the gradient and/or thickness of the build material on the work area and/or changing the z-position of the build material dispenser to change the gradient and/or thickness of the build material on the work area. In some examples, the changing of a build characteristic of the additive manufacturing process includes altering a energy profile and/or energy distribution from an energy source to alter an energy (e.g., an energy for fusion of the build material, etc.) and/or an agent (e.g., a binding agent, a chemical binder, BinderJet, a curable liquid binding agent, a fusing agent, a detailing agent, etc.) applied to a layer of build material, or any portion(s) of the layer of build material. In some examples, the agent includes an agent associated with accuracy and/or detail, an agent associated with opacity and/or translucency an agent associated with surface roughness, texture and/or friction, an agent associated with strength, elasticity and/or other material properties, an agent associated with color (e.g., surface and/or embedded) and/or an agent associated with electrical and/or thermal conductivity.

In some examples, the corrective actions are implemented by the additive manufacturing process not on the immediately affected layer (e.g., a layer having a flagged particle, etc.), but rather on a subsequently-applied layer of build material and/or during post-processing of the 3D object following completion of the 3D object. In some examples, the corrective actions are implemented by the additive manufacturing process not on an immediately affected 3D object, but rather on a subsequently built 3D object. For instance, the data obtained during the additive manufacturing process may be used to dynamically update a parameter of the additive manufacturing processes and/or is used to update a parameter of a subsequent additive manufacturing process if the issue identified would be expected to be replicated on a subsequently printed 3D object.

In some examples, the stereo vision systems and methods resolve the attributes of individual particles of build material and flag and map individual particles of build material in real time or in substantially real time (e.g., accounting for transmission and/or processing delays, etc.).

In some examples, the stereo vision system is able to discern a spatial distribution of build material particle sizes by analyzing the quality/amount of trackable texture within subsets used for stereoscopic depth extraction (small sub-regions of image used for correlation). The quality/amount of trackable texture within each subset is proportional to the number of particles resolved by the camera system. Since the stereo vision system provides a fixed spatial resolution for a particular imaging instance, it can measure a percentage of particles above or below a resolution threshold in the field of view (e.g., multiple cameras at different spatial resolutions could be used to digitally sieve the build material). In some examples, the stereo vision system 150 image data is used to derive a spatial distribution of build material particle sizes, a trackable texture of the particles, and location information of the particles, which can be used in combination to extract additional spatially resolved build material metrics (e.g., powder packing density, etc.).

To enable the 3D objects produced by the additive manufacturing process to be spatially modelled in 3D-space, in some examples, the model include details on the topography of each layer of build material for the 3D object produced and/or coordinates (X, Y, Z coordinates) representing and/or relating to the layer(s) (e.g., the local details of the layers).

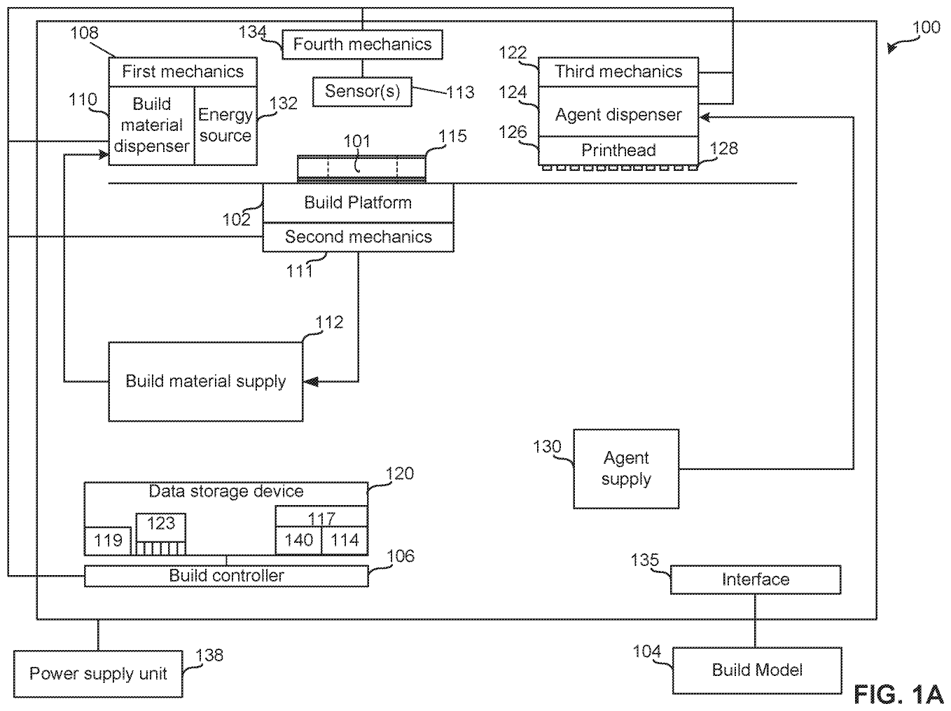

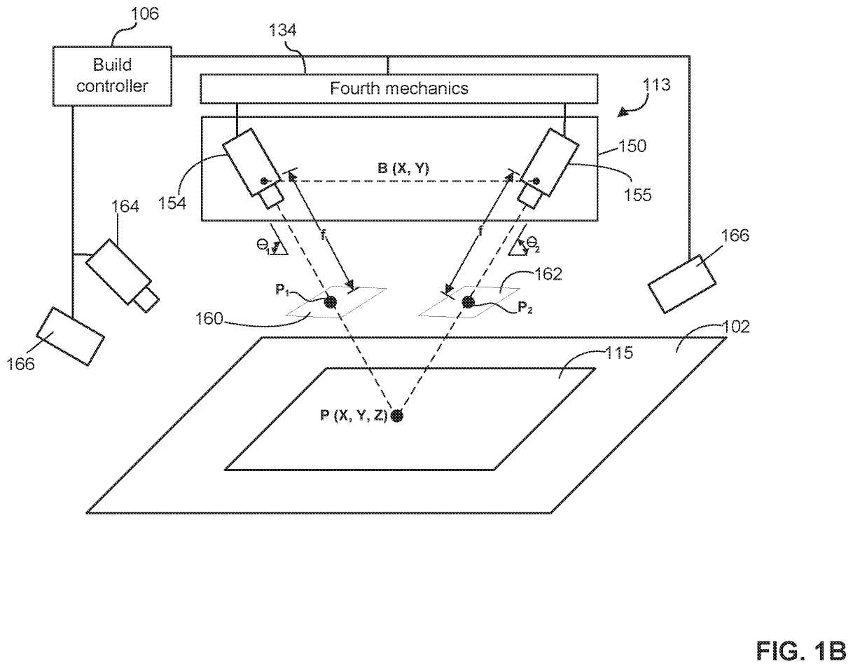

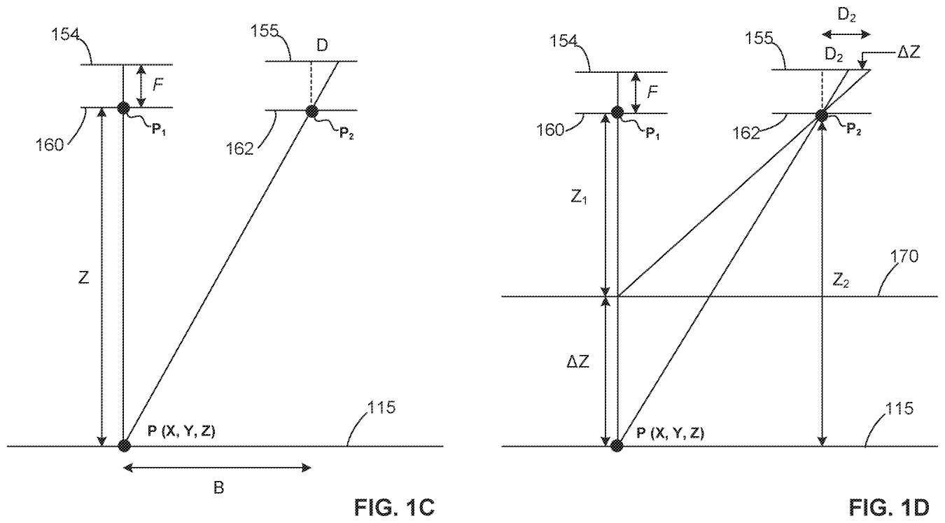

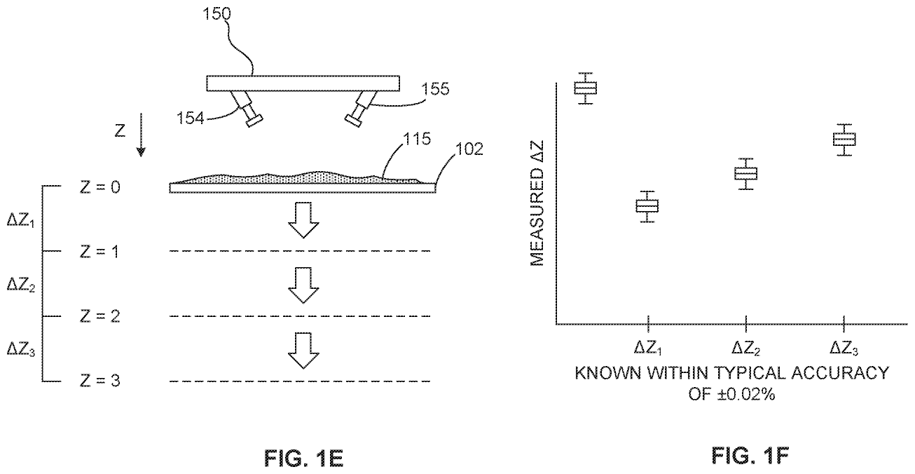

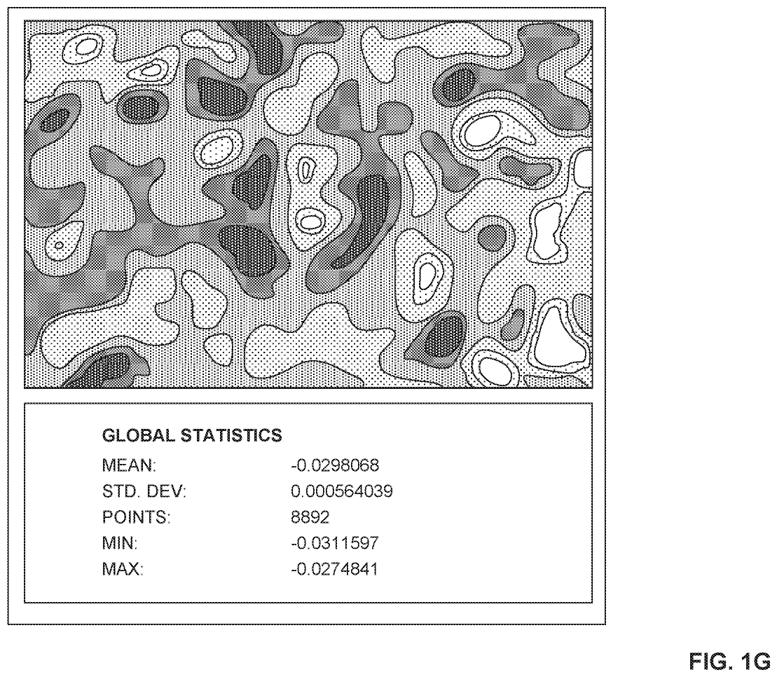

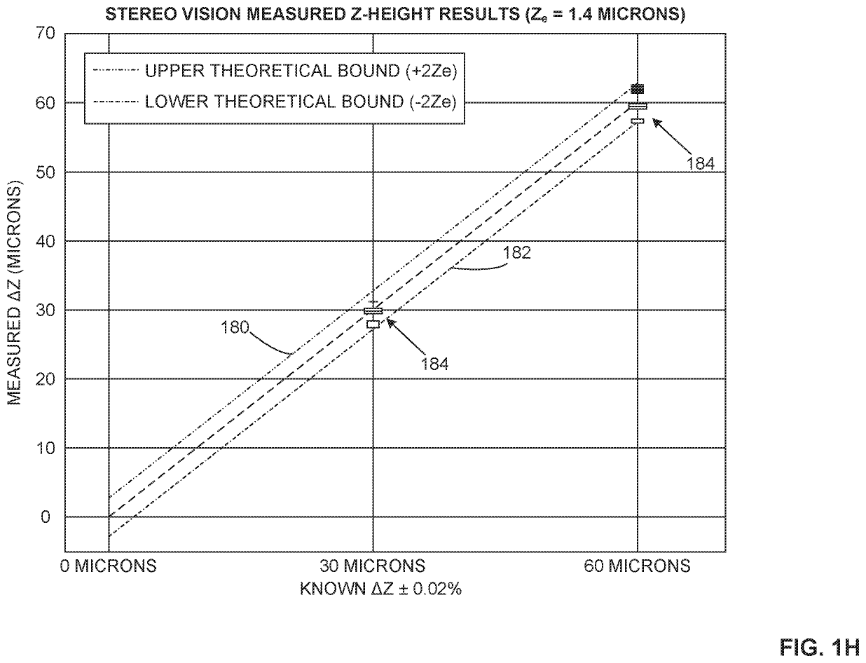

FIG. 1A is a block diagram of an example additive manufacturing apparatus and/or a 3D printer 100 that can be used to implement the teachings of this disclosure. In this example, the 3D printer 100 is to generate a 3D object 101 (e.g., a part, a structure, etc.). To generate an example 3D object 101 on an example work area (e.g., a build platform) 102, in the illustrated example, the 3D printer 100 implements an example build model 104 including data describing a 3D object 101 to be produced on the build platform 102. In some examples, the build platform 102 is removable from and/or attachable to the 3D printer 100. In some examples, the build platform 102 is coupled to the 3D printer 100.

To produce the 3D object 101 on the build platform 102 based on the build model and/or other data describing the 3D object 101, an example build controller 106 causes example first mechanics 108 to move an example build material dispenser 110 relative to the build platform 102 to dispense, spread and/or distribute a layer(s) of build material on the build platform 102. In some examples, the build material dispenser 110 includes a wiper, a spreader, a roller, a blade, a brush or the like, to distribute and/or dispense a layer of build material on the build platform 102. To achieve a selected build material thickness and/or a selected gradient of build material, the build material dispenser 110 is movable via the first mechanics 108 and/or the build platform 102 is movable via second mechanics 111. In some examples, the mechanics (e.g., the first mechanics 108, the second mechanics 111, etc.) includes a motor, an actuator, a track, and/or a rack and pinion to facilitate relative movement of the movable object (e.g., the build material dispenser 110, the build platform 102, etc.).

In the illustrated example, the build material is accessed from an example build material supply 112. In some examples, unused and/or excess build material is returned to the build material supply 112 via a gravity feed pathway (e.g., a conduit, etc.) and/or a conveyance system (e.g., a conveyor, etc.). In some examples, the non-solidified build material is directly returned to the build material supply 112 without being processed. In some examples, the build material is processed prior to returning the build material to the build material supply 112. In the example 3D printer 100 of FIG. 1A, the build material dispenser 110 dispenses the build material directly on the build platform 102. In some examples, the build material dispenser 110 includes a build material distributer and a recoater, where the build material distributer distributes build material onto a staging area of the 3D printer 100 adjacent the build platform 102 and the recoater dispenses, spreads and/or distributes layers of build material on the build platform 102. In such examples, the staging area may be adjacent to and/or part of the build platform 102.

To enable characteristics of the layers of deposited build material to be determined, the example 3D printer 100 includes a sensor 113 to generate sensor data. In some examples, the sensor 113 is implemented by a 3D imaging device such as, but not limited to, a stereo camera and/or an infrared (IR) stereo camera and/or an array of imaging devices (e.g., a complementary metal-oxide-semiconductor (CMOS) sensor array, a microelectromechanical systems (MEMS) array, etc.). However, the sensor 113 may be implemented in any other way to enable metrics 114 and/or characteristics of the build material, the layers and/or the 3D object 101 being formed to be determined and, in particular, to resolve attributes of individual powder particles (e.g., size, color, x-position, y-position, z-position, etc.), layer by layer, during a build process.

In examples in which the sensor 113 are implemented by an example stereoscopic imager, the sensor 113 obtains image data (e.g., sensor data) that is processed by the example build controller 106 to enable metrics 114 of the build material and/or the layer to be determined. Some of the metrics 114 may include a topography of the upper-most layer of build material, a thickness of the each layer of build material and each area of build material on the build platform 102, a z-height of each area of each layer of build material on the build platform 102, coordinates describing the layer and/or the 3D object 101 being formed on the build platform 102, and/or attributes of individual powder particles (e.g., size, color, x-position, y-position, z-position, etc.). For instance, the stereoscopic imager generates a build-material thickness map mapping a true z-height of each particle of build material and/or each region of build material in each layer. In some examples, the determined z-height of each area (e.g., a particle size area, an area larger than a particle of build material, an area larger than a plurality of particles of build material, etc.) of each layer is compared to the determined z-height of each corresponding area of a previously applied layer to determine a z-height difference, or thickness, therebetween.

In some examples, the processing includes performing an analysis on the sensor data (e.g., the image data) in which z-height data (e.g., stereoscopic Z-height data) of all layers on the build platform 102 is determined and then subtracted from the z-height data of the layers on the build platform 102 not including the upper-most layer. For instance, the thickness of any portion of a current layer (e.g., the upper-most layer) 115 on the build platform 102 may be determined by subtracting the cumulative z-height of corresponding portions of layer(s) underlying the portion(s) of interest. In some examples, the sensor 113 performs a first z-height determination to determine a z-height of each area of the layer 115 (e.g., a particle size area, an area larger than a particle of build material, an area larger than a plurality of particles of build material, up to and including an entirety of the layer 115) following deposit of the build material, but prior to application of an agent, performs a second z-height determination following application of an agent to the layer 115 of build material, and performs a third z-height determination following application of energy (e.g., thermal fusing, etc.) via the energy source 132 to selected portions of the layer 115.

In some examples, the build controller 106 generates and/or updates a model 117 representing (e.g., visually represent, structurally represent, etc.) the 3D object 101 produced and/or being produced. By analyzing the model 117 and/or comparing data of the model 117 to reference data 119 for the build model 104, the model 117 may be used to qualify the 3D object 101 being formed by the example 3D printer 100 when the qualifications indicate that the layer and/or the 3D object 101 being formed satisfy a quality threshold. In some examples, the reference data 119 includes data associated with the 3D object 101 being formed, the sensor data includes unprocessed data (e.g., image data) accessed from the sensor 113 and the determined metrics 114 include the results from processing the sensor data including, for example, data describing the topography of the layer 115, dimensions of the layer 115, dimensions and/or characteristics of the 3D object 101 being formed, etc.

To determine if the layer 115 of the build platform 102 is within a threshold of the associated layer described by the build model and/or other data, in some examples, the build controller 106 compares the determined metrics 114 from the model 117 to the reference data 119 from a data storage device 120. In this example, the metrics 114, the model 117 and the reference data 119 are stored in the data storage device 120. In examples in which the metrics 114 of the layer 115 and/or the 3D object 101 being formed on the build platform 102 satisfies a threshold of the reference data 119, the build controller 106 associates the layer with satisfying the reference data 119. In examples in which the metrics 114 of the layer 115 and/or the 3D object 101 being formed on the build platform 102 do not satisfy a threshold of the reference data 119, the build controller 106 associates the layer as not satisfying the reference data 119. Additionally and/or alternatively, in examples in which the metrics 114 of the layer 115 and/or the 3D object 101 being formed on the build platform 102 do not satisfy a threshold of the reference data 119, the build controller 106 determines whether to continue the additive manufacturing process.

If the layer 115 is determined to possess a characteristic (e.g., a flagged particle, etc.) determined by the build controller 106 not to satisfy a quality threshold of the metrics 114, the build controller 106 determines if the characteristic is rectifiable via a corrective action or if the 3D object 101 is to be rejected.

In some examples, the build controller 106 rectifies the characteristic(s) by causing the first mechanics 108 to move the example build material dispenser 110 relative to the build platform 102 to change characteristics of the upper-most layer of build material on the build platform 102. In some examples, the build controller 106 rectifies the characteristic(s) by causing the second mechanics 111 to move the example build platform 102 to enable characteristics of the upper-most layer of build material on the build platform 102 to change prior to, while and/or after the build material dispenser 110 is moved relative to the build platform 102.

To plan how the build material is to be selectively fused and/or to rectify the characteristic(s) of an applied layer of build material, the build controller 106 selects a energy profile from a plurality of energy profiles 123. In this example, the energy profiles 123 are stored in the data storage device 120. The energy profile may be associated with the determined metrics 114, the build material and/or the layer 115. In some examples, the energy profile may cause more or less agent to be deposited on the layer 115 of build material and/or may cause more or less energy to be applied to the layer 115 of build material when causing the build material to be selectively fused together. For example, if a local increase in powder layer thickness near position X, Y within the build layer is detected, the energy profile (e.g., the selected energy profile, the generated energy profile) may cause more agent/energy to be applied adjacent the position X, Y to enable and/or assure complete fusion. In other examples, if a local decrease in powder layer thickness near position X, Y within the build layer is detected, the energy profile (e.g., the selected energy profile, the generated energy profile) may cause the amount of agent/energy to be decreased adjacent the position X, Y (e.g., where measurements indicate thin powder regions) to avoid flooding adjacent the position X, Y with liquid (e.g., adding too much liquid) and/or overheating of the part adjacent the X, Y position. In other words, if a deviation in the physical build process is detected, in some examples, the input parameters are altered to achieve a desired result based on the situation. In some examples, an amount of agent/energy to apply is determined using equations/models that estimate, for example, fluid penetration depth/melting depth as a function of measured build metric deviations and material properties. Some material properties may include a fluid penetration coefficient, a thermal transfer coefficient, a melting point, etc. In some examples, the results are extrapolated from models to determine initial values for these parameters based on assumed and/or estimated build metrics.

To enable the agent to be dispensed on the layer 115 of build material, the build controller 106 causes example third mechanics 122 to move an example agent dispenser 124 of an example print head 126 is moved relative to the build platform 102 and over the layer 115 of build material. In some examples, the example nozzles 128 of the agent dispenser 124 deposit agent on the build material in accordance with the selected energy profile as the nozzles 128 are moved by the third mechanics 122.

In the illustrated example, the agent dispenser 124 and/or the print head 126 draws and/or accesses the agent from an example agent supply 130. The agent supply 130 may include a chamber(s) (e.g., 1, 2, 3, etc.) that houses an agent(s) (e.g., 1, 2, 3, 4 types of agents) and/or another liquid(s) used during the additive manufacturing process.

In some examples, during and/or after the nozzles 128 selectively deposit the agent on the build material, the sensor 113 obtains image data and/or the build controller 106 otherwise accesses data associated with the agent dispenser 124 and/or the 3D object 101 being produced, the print head 126 and/or the nozzles 128. The build controller 106 processes the data to determine an agent dispensing characteristic(s) of the agent deposited, operating characteristics of the agent dispenser 124, the print head 126 and/or the nozzles 128.

To determine if the agent deposited satisfies a threshold of the corresponding reference energy profile, in some examples, the build controller 106 compares the agent dispensing characteristics to reference data 119 associated with the selected energy profile from the data storage device 120. In examples in which the determined agent dispensing characteristics satisfy a threshold of the reference data 119, the build controller 106 associates the agent dispensing characteristics of the layer 115 of build material with satisfying the reference data 119. In examples in which the determined agent dispensing characteristics do not satisfy a threshold of the reference data 119, the build controller 106 associates the agent dispensing characteristics of the layer 115 of build material with not satisfying the reference data 119.

In the illustrated example, to selectively fuse and/or solidify the build material where the agent has been applied to the layer 115, the build material controller 106 causes the first mechanics 108 to move an example energy source 132 relative to the build platform 102 in accordance with the selected energy profile and to apply energy to the build material on the build platform 102 in accordance with the selected energy profile. For example, in a chemical binder system, an energy source 132 may be used to dry or cure a binder agent. The energy source 132 may apply any type of energy to selectively cause the build material to fuse and/or solidify. For example, the energy source 132 may include an infra-red (IR) light source, a near infra-red light source, a laser, etc. While the energy source is illustrated in FIG. 1 as being positioned adjacent the build material dispenser 110 and moved by the first mechanics 108, in other examples, the energy source 132 may be positioned adjacent the agent dispenser 124 and moved by the third mechanics 122. In other examples, the energy source 132 may be movable via dedicated mechanics or may be stationary relative to the build platform 102.

In some examples, the sensor 113 obtains image data for the layer 115 of build material after application of the layer 115, after application of an agent to the layer 115 and/or after application energy via the energy source 132 to fuse the layer 115. The build controller 106 uses the image data to determine if the layer 115 includes a particle of interest (e.g., a particle above a dimensional threshold, a particles having a particular shape, a particle deviating from a particular shape, etc.) and flags and maps any such particle(s) for evaluation by the build controller 106 in relation to critical build structures for the 3D object 101 defined in the build model 104. For instance, the build controller 106 is to access the build model 104 to determine if a location (X, Y, Z) of a flagged particle relative to the layer 115 and/or relative to the 3D object 101 being formed using the build model 104 lies in a critical or a non-critical area (e.g., outside of an object later, etc.) and, consequently, determines whether any corrective action is required to be implemented to the layer 115 to ensure that the 3D object produced by the additive manufacturing process satisfies 3D object 101 build criteria. In some examples, the sensor 113 is movable via fourth mechanics 134 which may include, by way of example, motor(s), actuator(s), track(s), and/or rack(s) and pinion(s) to facilitate relative movement of the sensor 113 relative to the build platform 102. In an example discussed below in FIG. 1B, the sensor 113 includes a first camera and a second camera, separated by a distance B, that may be aimed at a common focal point and/or moved relative or one another and/or moved relative to the build platform 102 via the fourth mechanics 134.

In the illustrated example, the example 3D printer 100 of FIG. 1 includes an interface 135 to interface with the build model 104. The interface 135 may be a wired or wireless connection connecting the 3D printer 100 and the build model 104. The build model 104 may be a computing device from which the 3D printer 100 receives data describing a task (e.g., an object to form, a print job, etc.) to be executed by the build controller 106. In some examples, the interface 135 facilitates the 3D printer 100 and/or the build controller 106 to interface with various hardware elements, such as the build model 104 and/or hardware elements that are external and/or internal to the 3D printer 100. In some examples, the interface 135 interfaces with an input or output device, such as, for example, a display device, a mouse, a keyboard, etc. The interface 135 may also provide access to other external devices such as an external storage device, network devices, such as, for example, servers, switches, routers, client devices, other types of computing devices and/or combinations thereof.

In some examples, the example build controller 106 includes hardware architecture, to retrieve and execute executable code from the example data storage device 120. The executable code may, when executed by the build controller 106, cause the build controller 106 to implement at least the functionality of controlling the first mechanics 108 and/or the build material dispenser 110 to dispense build material on the build platform 102 based on the build model 104 and/or other data describing the 3D object 101. The executable code may, when executed by the build controller 106, cause the build controller 106 to implement at least the functionality of controlling the first mechanics 108 and/or the energy source 132 to apply energy to the layer 115 of build material on the build platform 102.

The executable code may, when executed by the build controller 106, cause the build controller 106 to implement at least the functionality of controlling the second mechanics 111 and/or the agent dispenser 124 including the associated print head 126 and the nozzles 128 to dispense the agent onto the build material based on the build model 104 and/or other data describing the 3D object 101.

The executable code may, when executed by the build controller 106, cause the build controller 106 to implement at least the functionality of controlling the third mechanics 122 and/or the agent dispenser 124 to dispense an agent on the layer 115 of build material on the build platform 102 based on the build model 104 and/or other data describing the 3D object 101.

The executable code may, when executed by the build controller 106, cause the build controller 106 to implement at least the functionality of controlling the fourth mechanics 134 to control a position of the sensor 113 relative to the build platform 102 and/or the layer 115 of the 3D object 101 formed in accord with the build model 104.

The executable code may, when executed by the build controller 106, cause the build controller 106 to select and/or update a parameter of the additive manufacturing process based on metrics 114 of the layer 115 and/or 3D object 101 being formed to enable the 3D object 101 produced (e.g., current object produced, subsequent objects produced, etc.) using the examples disclosed herein to satisfy a quality threshold. The executable code may, when executed by the build controller 106, cause the build controller 106 to generate an alert and/or to otherwise reject the part being produced if the 3D object 101 does not satisfy the quality threshold.

The data storage device 120 of FIG. 1 stores instructions that are executed by the build controller 106 and/or other processing devices. The example data storage device 120 may store computer code representing a number of applications, firmware, machine readable instructions, etc. that the example build controller 106 and/or other processing devices executes to implement the examples disclosed herein.

FIG. 1B is a schematic drawing of an example sensor 113 including an example stereo vision system 150 with dual angled stereo cameras, an example first camera 154 and an example second camera 155, separated by a distance B (e.g., a baseline or interocular distance) and aligned to image the particles of the build material in the layer 115 of build material. In some examples, the stereo vision system 150 uses a calibration error factor to facilitate measurement reliability. Collectively, any surface feature (e.g., a particle P, etc.) present in the image data from each of the first camera 154 and the second camera 155 may be referred to herein as a common feature. In some examples, the stereo vision system 150 includes a fiducial to facilitate processing of common features (e.g., particles, etc.) with flat or fine surfaces by assisting processing of recorded image data from the first camera 154 and the second camera 155. For ease of description, a Cartesian (X, Y, Z) coordinate system 24 is used herein, although other coordinate systems (e.g., a polar coordinate system, etc.) may be used. In some examples, the terms “up and down” relate to the z direction, “left and right” relate to the x direction, and “in and out of the page” relate to the y-direction. These descriptors are not meant to be limiting and the axis may be oriented differently and other coordinate systems may be used. For this disclosure, the Z-axis represents a z-height dimension and the X-axis and the Y-axis represent a plane perpendicular to the Z-axis.

In this example, a common feature P (e.g., a particle, a clump of particles, etc.) is initially viewed by the first camera 154 as a first surface feature P₁ on a first projection plane 160, a projection of the common feature P in an image acquired by the first camera 154 and viewed by the second camera 155 as a second surface feature P₂ on a second projection plane 162, a projection of the common feature P in an image acquired by the second camera 155. The X-coordinate of P₁ is given by f*X/Z and the X-coordinate of P₂ is given by f*(X−B)/Z. The distance between P₁ and P₂ is the “disparity distance” D shown in FIGS. 1C-1D, which can be used to calculate depth information between the common feature P and the stereo vision system 150. The disparity distance D is represented as by (f*B)/Z. Since a common feature P may overlap multiple pixels, image processing routines may be used to align and correlate the image data from the first camera 154 and the image data from the second camera 155 and to determine the measured disparity distance(s) within a sub-pixel accuracy by using interpolation techniques. Due to optical configurations, orientations errors, and other factors, the image data from the first camera 154 and the image data from the second camera 155 may not represent the common feature P are being of the same size, alignment and/or shape. In some examples, rectification, or another image processing function, is used to resize and reshape images to improve alignment and correlation. In some examples, rectification includes correcting an image to match an image sensor geometry and/or correcting image data to account for any expected optical distortions.

In some examples, such as shown in the example of FIG. 1B, the first camera 154 and the second camera 155 are disposed at substantially similar opposing angles Θ₁ and Θ₂ to a X-Y plane defined by a surface area (e.g., layer 115) under inspection. In some examples, the opposing angles Θ₁ and Θ₂ are about 45° or more (e.g., between about 55° to about 70° degrees, etc.). In some examples, the first camera 154 is substantially aligned with the Z-axis (e.g., Θ₂=about 90°) and the second camera 155 is disposed at another angle (e.g., Θ₁=between about 45° to about 85°). In some examples, Θ₁ and Θ₂ are substantially the same angle and, in other examples, Θ₁ and Θ₂ are different angles. The stereo vision system 150 enhances contrast and surface detail of common feature P in the image data from the first camera 154 and the image data from the second camera 155.

In some examples, the first camera 154 and the second camera 155 are separated by the separation distance B, larger than a dimension of the surface (e.g., layer 115) to be images (e.g., a dimension of a side of the layer 115, etc.) to enhance resolution. Increasing the separation distance B may increase accuracy, but may also lower resolution by limiting the closest common feature that can be discerned. Increasing the separation distance B may also reduce a percentage of valid disparity distance pixels as the image overlap is less certain due to image sheer. In some instances, the angling of the first camera 154 and the second camera 155 introduces difficulties in maintaining a consistent focus or depth of field (DOF) over the entire field of view (FOV) of an imaged surface area (e.g., layer 115). The DOF is dependent on the camera, lens, and geometry of the configured system. The DOF may be increased by using a larger lens f-number, decreasing the focal length (f) of the lens, using an image sensor with a larger circle of confusion, and increasing the distance of the camera from the surface area to be imaged. Minimizing the opposing angles also increases the possibility of greater occlusion and more variation in appearance of the common feature P between the first camera 154 and the second camera 155.

In some examples, the sensor 113 includes an example color camera 164 to facilitate sensing of color-based metrics 114 of the build material and/or the layer 115.

In some examples, an example light source 166 (e.g., a visible light source, an infrared (IR) light source, etc.) is provided to illuminate the surface area to be imaged (e.g., layer 115, etc.) to enhance an image texture of the surface area to be imaged (e.g., by reducing shadows, by reducing light speckle, by reducing undesired reflections, etc.). In some examples, the light source 166 is specifically selected for the surface area and/or surface feature to be imaged to provide a selected light (e.g., visible, IR, etc.) at the proper angles, frequency(cies), polarization, and intensity needed to resolve the common features P. In some examples, the light source 166 includes a plurality of light sources that may emit the same type of light, or different types of light. The light source 166 may have its intensity, polarization, and color controlled by the build controller 106 to provide different illumination levels and/or sources of illumination depending on the surface area (e.g., layer 115) to be imaged and/or the sources of illumination. For instance, a higher intensity light may be used for unprocessed build material layers and a lower intensity light may be used for processed build material layers which may have greater reflections due to the sintered or formed build material having more reflective surfaces.

In some examples, the light source 166 is monochromatic to reduce color aberrations in the camera lenses and thereby increase accuracy of the z-measurement readings. In some examples, the light source 166 has multiple complementary different polarized light sources, programmable or fixed, with complementary different polarizing filters on the first camera 154 and/or the second camera 155 provided to reduce reflections and enhance surface texture. In some examples, cross polarizing is employed to eliminate asymmetric reflections and facilitate stereoscopic correlation (i.e., depth extraction). In such examples, the lens of the first camera 154, the lens of the second camera 155 and the light source 166 are polarized (e.g., including a polarizing filter, etc.) to control the lighting conditions. In some examples, the polarizing filter is adjustable such that reflections negatively impacting identification of the common feature P can be filtered out.

FIG. 1C shows an example arrangement of the first camera 154 and the second camera 155 focused on a common feature P at a location (X, Y, Z) of layer 115. Z represents the perpendicular distance (e.g., in meters or another unit of measurement) from the stereo vision system 150 to the common feature P or target. The lens focal length (e.g., in pixels or another unit of measurement) is represented as “f.” B is the baseline distance between the first camera 154 and the second camera 155 (e.g., in meters or another unit of measurement). D represents the disparity between the common feature P in stereo images (e.g., in pixels or another unit of measurement). The depth Z is represented by (f*B)/D.

FIG. 1D shows an example where the geometry of an example stereo vision system 150 is used to determine Z-height resolution with respect to the layer 115 and a surface 170. Using the previous relationship, the difference in any two z-height measurements can be written:

$$Δ Z = {Z}_{2} - {Z}_{1} = \frac{fB}{{D}_{2}} - \frac{fB}{{D}_{1}} = fB ( \frac{Δ D}{{D}_{1} {D}_{2}} ) \qquad ( Eq . 1 )$$

The measurement resolution is obtained by minimizing the above result:

$$min ( Δ Z ) = min ( fB ( \frac{Δ D}{{D}_{1} {D}_{2}} ) ) = fB ( \frac{min ( Δ D )}{{D}^{2}} ) \qquad ( Eq . 2 )$$

where min(ΔD) is the sub-pixel interpolation applied to measure disparity between common features in stereo image pairs. This ideal resolution is then adapted to a practical application by including calibration errors to obtain realistic approximations of z-height measurement error. In some examples, to account for this uncertainty when measuring pixel disparity, the resolution is converted to error approximation by adding the projected calibration error ε (in pixels) to the sub-pixel interpolation

$$min ( Δ Z ) = fb ( \frac{min ( Δ D )}{{D}^{2}} ) \qquad ( Eq . 3 )$$

This gives rise to a closed-form approximation for Z-height measurement error:

$${Z}_{e} = fB ( \frac{min ( Δ D ) + ɛ}{{D}^{2}} ) = {Z}^{2} ( \frac{min ( Δ D ) + ɛ}{fB} ) \qquad ( Eq . 4 )$$

FIGS. 1E-1F show an example manner of determining Z-height measurement accuracy where the sensor 113 (e.g., stereo vision system 150) accuracy is obtained directly through experimentation using the precision of the build platform 102 to provide known height changes. During the determination, the build platform 102 is incremented downwardly, as shown in FIG. 1E, through a number n (e.g., n=3 in the example of FIG. 1E) of Z-positions. For each of the Z-positions of the build platform 102, the measured ΔZ (e.g., ΔZ₁, ΔZ₂, ΔZ₃, etc.) is determined with an accuracy of about +/−0.02%. In some examples, the stereo vision system 150 experimentally verifies the closed-form approximation using 115 mm lenses with a 15 μm/pixel spatial resolution. In some examples, an instantiation of the sensor 113 (e.g., stereo vision system 150) is performed every time verification of measurement accuracy is desired.

FIG. 1G shows a representation of an example screenshot from a VIC-3D program showing example ΔZ global statistics for a platform drop of 30 μm. FIG. 1H shows an example plot of the example measured ΔZ data (in microns) of FIG. 1G against the known ΔZ (about +/−0.02%). A corresponding upper theoretical bound 180 (+2Zₑ) and lower theoretical bound 182 (−2Zₑ) (ε=0.073 pixel, min(ΔD)=0.0625 pixel, B=687 mm, Z=600 mm) are represented as boxplots 184 at 30 microns and at 60 microns.

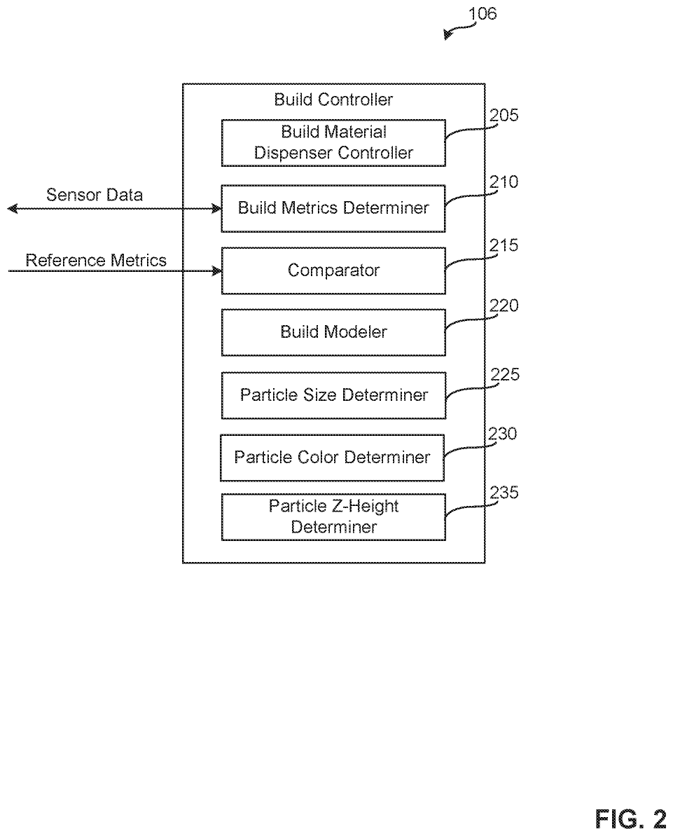

FIG. 2 illustrates an example implementation of the example build controller 106 of FIG. 1. As shown in the example of FIG. 2, the build controller 106 includes an example an example build material dispenser controller 205, an example build controller 106, an example comparator 215, an example build modeler 220, an example particle size determiner 225, an example particle color determiner 230 and an example particle z-height determiner 235.

The build material dispenser controller 205 is to cause the build material dispenser 110 to move relative to the build platform 102 to dispense build material in accord with the build model 104.

The build controller 106 is to access data from the sensor 113, the first mechanics 108 and/or the build material dispenser 110 and to process the data to determine the metrics 114 of the layer of build material on the build platform 102. The metrics 114 may include the topography of the upper-most layer of build material, the thickness of the build material and/or the upper-most layer, dimensions of the upper-most layer including local dimensions, coordinates describing the layer and/or its topography and/or the 3D object 101 being formed on the build platform 102, etc. In some examples, the metrics 114 include pixel-level details and/or voxel-level details on the build material and/or the layer on the build platform 102. In some examples, the metrics 114 may include any additional and/or alternative data relating to the additive manufacturing process taking place.

To determine if the metrics 114 of the layer 115 of build material on the build platform 102 are within a threshold of the corresponding reference data 119, the comparator 215 compares the determined metrics 114 and the reference data 119 from the data storage device 120 and the build model 104 and determines if the determined metrics 114 are within a threshold of reference data 119. In examples in which the metrics 114 of the layer 115 and/or the 3D object 101 being formed on the build platform 102 satisfy a threshold of the reference data 119, the comparator 215 associates the layer with satisfying the reference data 119. Additionally or alternatively, in examples in which the metrics 114 of the layer 115 and/or the 3D object 101 being formed on the build platform 102 do not satisfy a threshold of the reference data 119, the comparator 215 associates the layer as not satisfying the reference data 119 and the build modeler 220 determines whether to continue the additive manufacturing process in view of the departure of the build from the build model 104 indicated by the failure to satisfy the reference data 119.

When the metrics 114 do not satisfy a threshold of the reference data 119 and the build modeler 220 determines that the departure indicated by the reference data 119 is not able to be rectified via processing and/or post-processing, the build modeler 220 may reject the 3D object 101 being formed and discontinue the additive manufacturing process for the 3D object 101. In other examples, where the build modeler 220 determines that the departure of the build from the build model 104 is rectifiable, the build modeler 220 may cause the build material dispenser controller 205 to change the thickness of the layer 115 and/or change the topography/gradient of the layer 115, cause the build platform 102 to change its position to enable the build material dispenser 110 to change the thickness and/or the topography/gradient of the layer 115 (e.g., using a roller, scraper or other manipulator to remove and/or redistribute the layer of build material, etc.). In some such examples, following a modification of the layer 115 by the build material dispenser 110, the sensor 113 obtains updated image data which the build controller 106 uses to determine updated metrics of the layer and/or the 3D object 101 being built and the build modeler 220 determines whether the layer 115 satisfies a threshold of the reference data 119.

The build modeler 220 generates and/or updates the model 117 which associates and/or maps the determined metrics 114 and the layer 115 for the 3D object 101 being formed. In some examples, the model 117 includes details on the time that the layer was formed, coordinates (X, Y, Z coordinates) representing and/or relating to the layer(s) and/or the topography of the layer(s) and/or constituent part(s) of the layer(s) (e.g., a particle map, etc.). In some examples, the coordinates (X, Y, Z coordinates) representing and/or relating to the layer(s) and/or the topography of the layer(s) and/or constituent part(s) of the layer(s) (e.g., a particle map, etc.) are mapped to the 3D object 101 itself.

In some examples, the build controller 106, the comparator 215 and/or the build modeler 220 determine whether the layer 115 and/or a subpart of the layer 115 satisfies a threshold of the reference data 119 via the example particle size determiner 225, the example particle color determiner 230 and/or the example particle z-height determiner 235. In some examples, image data from the sensor 113 includes stereoscopic image data that is processed by the example build controller 106 to enable metrics 114 of the build material and/or the layer 115 to be determined, including a true thickness, a powder layer thickness, a fused layer thickness and/or particle metrics. In some examples, the particle metrics include a build material particle size (e.g., 10 μm, 20 μm, 40 μm, 60 μm, 80 μm, etc.) determined via the particle size determiner 225 using the image data (e.g., stereoscopic image data, etc.) from the sensor 113. In some examples, the particle metrics include a particle color determined via the particle color determiner 230 using the image data (e.g., stereoscopic image data, etc.) from the sensor 113. In some examples, the sensor 113 includes the color camera 164 to facilitate sensing of color-based metrics 114 of the build material and/or the layer 115. For instance, where a build material includes a white polymeric powder, a thickness of a subportion of the layer 115 that is less than that of the design thickness could be expected to overheat when the energy source 132 applies energy to the layer 115, darkening the build material at that subportion relative to adjoining portions of the layer 115 having a thickness corresponding to the design thickness of the build model 104. In some examples, the sensor 113 includes a color stereo vision system or includes a stereo vision system and a separate color imager. In some examples, the particle metrics include a particle z-height determined via the particle z-height determiner 235 using the image data (e.g., stereoscopic image data, etc.) from the sensor 113. In some examples, the particle z-height includes a particle location (X, Y, Z location) with respect to a predetermined (e.g., calibrated) coordinate system and/or a particle location relative to the layer 115 (e.g., a sub-elevated particle, a super-elevated particle, etc.).

While an example manner of implementing the build controller 106 of FIG. 1 is illustrated in FIG. 2, any one of the elements, processes and/or devices illustrated in FIG. 2 may be combined, divided, re-arranged, omitted, eliminated and/or implemented in any other way. In some examples, the build controller 106, the comparator 215 and/or the build modeler 220 determine whether the layer 115 and/or a subpart of the layer 115 (e.g., a particle, P) satisfies a threshold of the reference data 119 via the example particle size determiner 225, the example particle color determiner 230 and/or the example particle z-height determiner 235. The build controller 106, the comparator 215, the build modeler 220, the particle size determiner 225, the particle color determiner 230 and/or the particle z-height determiner 235 and/or, more generally, the example build controller 106 of FIG. 1 may be implemented by hardware, software, firmware and/or any combination of hardware, software and/or firmware. Thus, for example, any of the build controller 106, the comparator 215, the build modeler 220, the particle size determiner 225, the particle color determiner 230 and/or the particle z-height determiner 235 and/or, more generally, the example build controller 106 of FIG. 1 could be implemented by an analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the build controller 106, the comparator 215, the build modeler 220, the particle size determiner 225, the particle color determiner 230 and/or the particle z-height determiner 235 and/or, more generally, the example build controller 106 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example build controller 106 of FIG. 1 may include an element(s), process(es) and/or devices in addition to, or instead of, those illustrated in FIG. 2, and/or may include more than one of any or all of the illustrated elements, processes and devices.

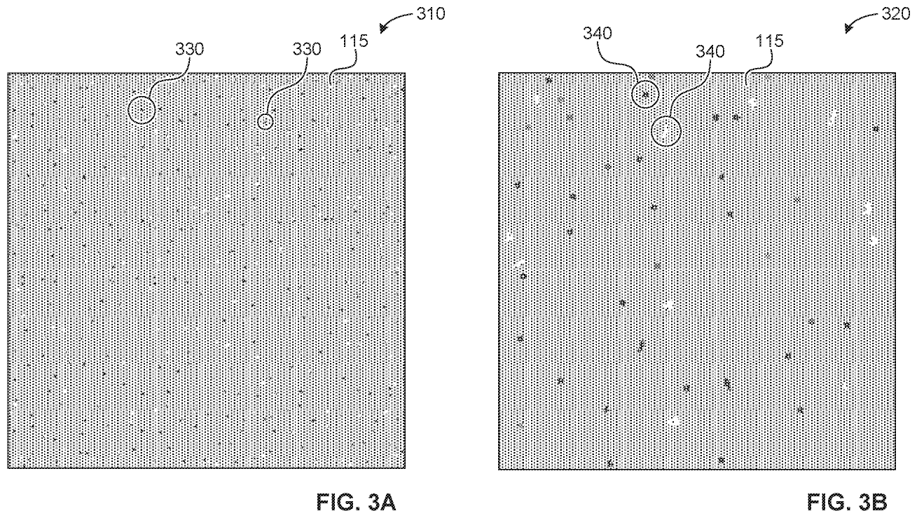

FIGS. 3A-3B are example top views 310, 320 of a layer 115 of build material applied by the 3D printer 100 of FIGS. 1A-1H during an example build process. The top view 310 of FIG. 3A represents an example field of view (FOV) of 6″×8″ with the first camera 154 and the second camera 155 being 12 megapixel cameras having 35 mm lenses and providing a resolution of 48 pm/pixel over the FOV. In FIG. 3A, the 3D printer 100 of FIGS. 1A-1H performs z-height measurements within at least 6.5 microns when the field of view is the 8″×6″ (e.g., an 8″×6″ build platform 102, etc.). FIG. 3A shows a speckling of the layer 115, with some particles 330 of a larger size than a balance of the build material forming the layer 115. The top view 320 of FIG. 3B represents an example field of view (FOV) of 2″×2.5″ with the first camera 154 and the second camera 155 being 12 megapixel cameras having 115 mm lenses and providing a resolution of 15 μm/pixel over the FOV. In FIG. 3B, the 3D printer 100 of FIGS. 1A-1H performs z-height measurements within at least 1.4 microns when the field of view is reduced to 2.5″×2″. Additional improvements may potentially be realized through further reductions in calibration error and z-height measurement error. Similar to FIG. 3A, FIG. 3B shows a speckling of the layer 115, with some particles 340 of a larger size than a balance of the build material forming the layer 115.

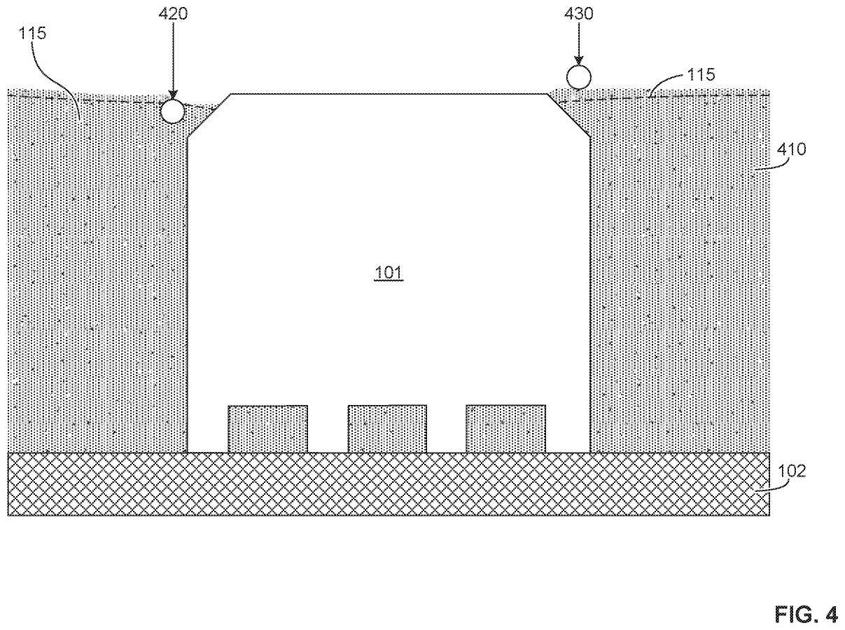

FIG. 4 is an example sectional-view of an example 3D object 101 during an example build process of the example 3D printer of FIGS. 1A-1H. In the example of FIG. 4, the object 101 lies amongst adjacent build material 410. A layer 115 applied atop the build material 410 includes an example first particle 420 that is sub-elevated (e.g., substantially beneath the layer 115) and an example second particle 430 that is super-elevated (e.g., substantially above the layer 115). The build controller 106 is to cause the sensor 113 and the particle size determiner 225, the particle color determiner 230 and/or the particle z-height determiner 235 to determine, respectively, the size, color and/or z-height of the first particle 420 and the second particle 430.

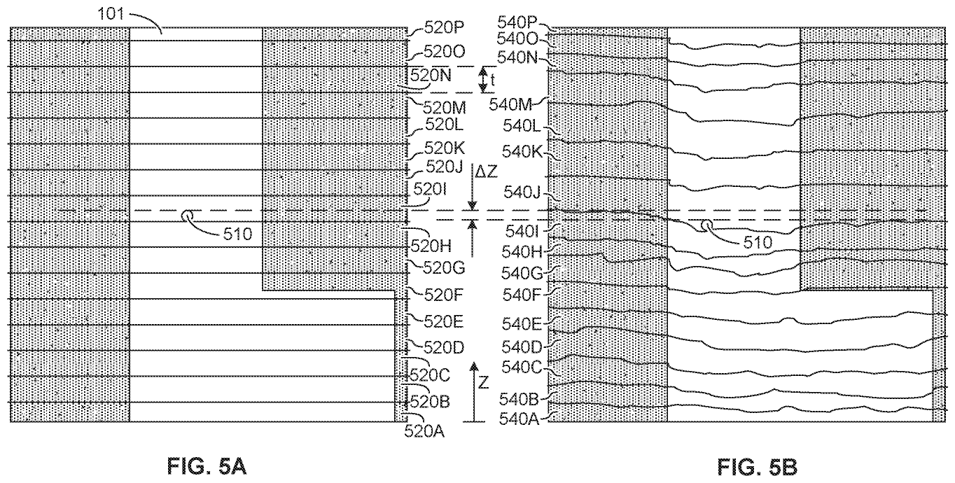

FIGS. 5A-5B are example sectional-views of an example 3D object 101 during an example build process of the example 3D printer of FIGS. 1A-1H using the sensor 113 (e.g., stereo vision system 150). FIG. 5A shows an idealized representation of a first Z-height for an example particle 510 wherein it is assumed that each of the layers 520A-520P of build material have a uniform thickness, t. In such example, the assumed Z-height may be taken to be the product of the nominal layer thickness t multiplied by the number of layers. In contrast, FIG. 5B depicts the particle 510 positioned at a second Z-height relative to layers 540A-540P exhibiting expected variances. In the example of FIG. 5B, the Z-height at a particular (X,Y) location is determined as

$$Z = {\sum }_{i = 1}^{N} {Z}_{N} ( X , Y ) \qquad ( Eq . 5 )$$

where Z is the Z-height, N is the layer number, and Z_{N}(X,Y) represents the Z-height at a specific (X,Y) location of each layer. Thus, the Z-height is calculated by summing the actual Z-height of each layer at the (X,Y) location.

Together, FIGS. 5A-5B show that an actual position of the particle 510 varies from a theoretical position of the particle 510 by a height of ΔZ, highlighting that assumptions regarding layer consistency can be expected to lead to errors in determining an actual Z-height of a particle 510. An accurate assessment of a height of a particle within a build of the 3D object 101 assists the build controller 106 to more accurately localize (e.g., via the comparator 215 and/or build modeler 220, particle z-height determiner 235, etc.) the particle 510 within the layer 115 and/or the 3D object 101, in view of the build model 104, to enable the build controller 106 to more accurately determine whether the particle 510 lies in a critical or a non-critical area. This, in turn, informs the corrective action to be performed during processing, if continued, or during post-processing (e.g., heat treatment, surface treatment, stress relief, inspection protocol, etc.).

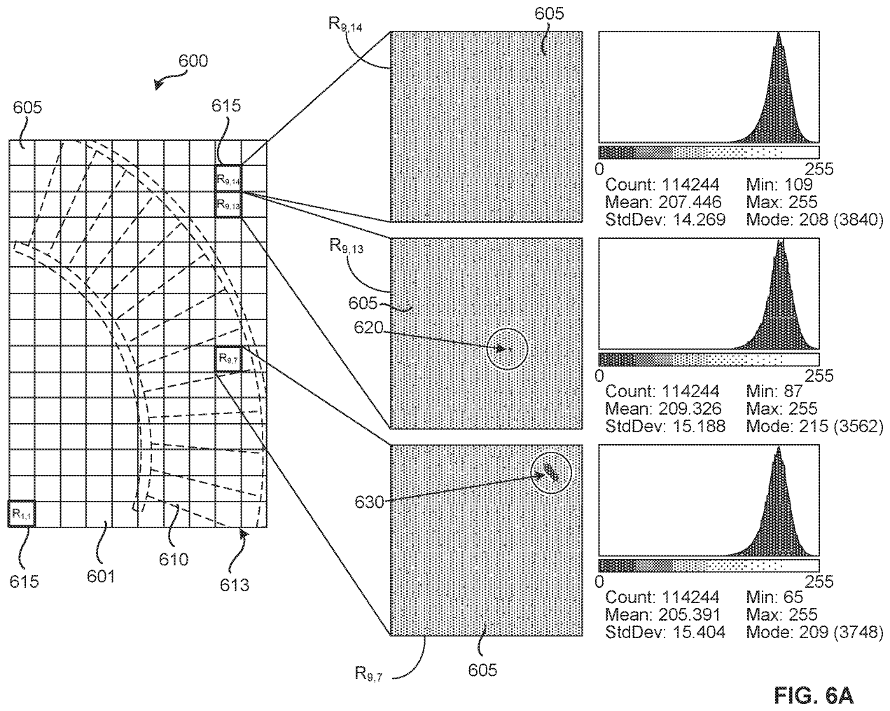

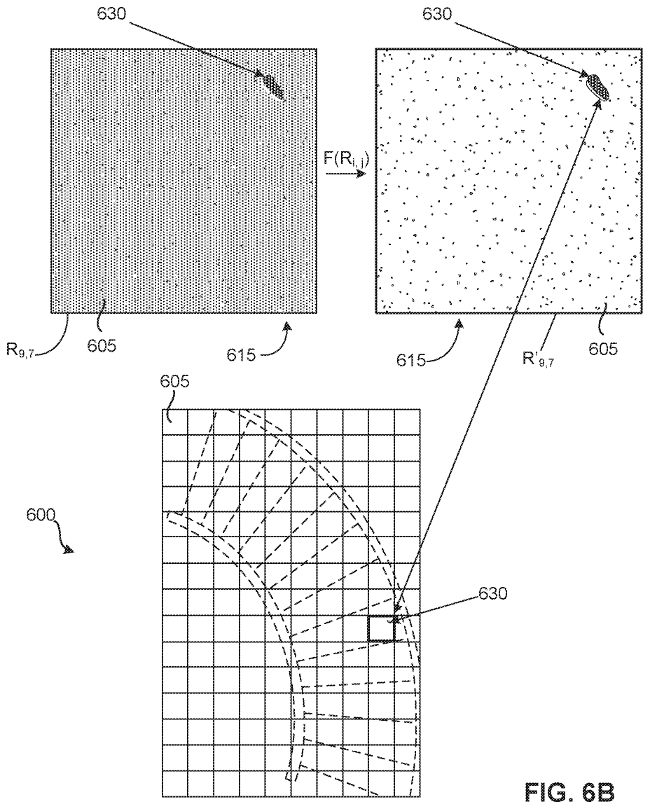

FIG. 6A shows an example stage 600 of an example build process using the 3D printer 100 of FIGS. 1A-1H, wherein an example sensor 113 (e.g., stereo vision system 150) images a layer 601 of build material 605 within the sensor 113 field of view (FOV). An example object 610 formed by the example build process, in this instance an example ring of example turbine blades, is shown in dashed lines below the layer 601 of build material 605. In some examples, the FOV is discretized to facilitate analysis. For instance, the FOV is divided into a plurality of regions, such as an array 613 of regions R_{i,j} 615, where i and j respectively represent integers for the row and column of each region the example array 613. In the example of FIG. 6A, the region R_{1,1} is highlighted in the lower left corner of the layer 601 of build material 605. Region R_{9,7}, region R_{9,13} and Region R_{9,14} are expanded to illustrate an example coarse texture analysis performed on the layer 601. In the coarse texture analysis performed on the layer 601, relationships between observable phenomenon and quantifiable image metrics are used to quickly reduce the number of regions R_{i,j} 615 or sub-images that undergo a focused analysis. For instance, powder and/or texture quality metrics are used to flag regional anomalies (e.g., a particle that is statistically different in one or more characteristics, such as size, shape, and/or color, relative to other particles in a selected region, etc.) that may warrant further analysis. In some examples, such as shown in the example of FIG. 6A, a standard deviation of a localized intensity histogram can be used to identify the presence of anomalies, such as large particles, in the regions R_{i,j} 615 or sub-images.

In FIG. 6A, the standard deviation of the localized intensity histogram of region R_{9,14} is 14.269 indicating, in this example, that there are no discernible anomalies in the population of particles in region R_{9,14}. The standard deviation of the localized intensity histogram of region R_{9,13} is 15.188 indicating, in this example, that there is a first anomaly 620 in the population of particles in region R_{9,13}. In this instance, the first anomaly 620 represents a particle that is significantly larger (e.g., greater than a predetermined threshold, etc.) than the other particles in region R_{9,13}. As represented in region R_{9,13} of FIG. 6A, the first anomaly 620 contributes to the increased standard deviation, but is below a predetermined threshold at which action is to be performed by the 3D printer 100. The standard deviation of the localized intensity histogram of region R_{9,7} is 15.404. In this example, that there is a second anomaly 630 in the population of particles in region R_{9,7} arising from a particle that is large relative to the other particles in region R_{9,7}. As represented in region R_{9,7}, the second anomaly 630 contributes to the increase of the standard deviation (e.g., relative to region R_{9,14} and/or a baseline) and exceeds the predetermined threshold (e.g., a standard deviation greater than 15.2 in the present example, etc.) at which action is to be performed by the 3D printer 100.

Following the coarse texture analysis of FIG. 6A and/or a plurality of iterations of one or more types of a coarse texture analysis, a focused analysis is performed on each of the regions R_{i,j} 615 exhibiting an anomaly (e.g., a particle that is statistically different in size, shape, color, etc. relative to other particles in a selected region, etc.), however determined.

In the focused analysis, represented in FIG. 6B, the anomaly or anomalies are accurately located within each region R_{i,j} 615 or sub-image. In the upper left image of FIG. 6B, the region R_{9,7} from the coarse texture analysis of FIG. 6A is shown. In some examples, to facilitate location of anomalies, the focused analysis includes application of image processing techniques (e.g., edge detection, thresholding and/or blob detection, etc.), represented as F(R_{i,j}), to the image data of region(s) R_{i,j} 615 flagged during the coarse texture analysis of FIG. 6A. In the upper right of FIG. 6B, image processing techniques F(R_{i,j}) (e.g., an edge detection algorithm) are applied to the example region R_{9,7} to accentuate boundaries of the second anomaly 630. In some examples, where the build material particle size is below about 10 μm, the image processing techniques F(R_{i,j}) may also include image stitching.

Following application of the image processing techniques to locate the anomaly or anomalies, attributes of the anomaly or anomalies are measured. In some examples, an anomaly may be defined by a variation, relative to background, in a size, shape, color, orientation and/or centroid (X-Y location) of a particle or particles. In some examples, the anomaly may be user-defined and/or process-defined to accommodate expected anomalies for a particular process and/or build material and/or object to be produced (e.g., reflecting differing quality control requirements for different objects). For instance, in some processes, it may be desired to map anomalies that are 60 μm or larger, whereas it may be desired to map anomalies that are 10 μm or larger in other processes. In the bottom image of FIG. 6B, the resolved image data from the focused analysis of region R_{9,7} is mapped back to the 3D object 101 via the build modeler 220.

Contemporaneously, either before or after the performing of the focused analysis, the anomaly or anomalies (e.g., a large particle, etc.) are precisely associated with a Z-height location within the build volume by correlating the (X,Y) position of each anomaly with stereo vision system 150 Z(X,Y) data measured on a layerwise basis in real-time or substantially in real-time. In some examples, a mapping of the position of each anomalous particle in each layer with an accurate Z-height thereof (e.g., to a precision of ⅙ of a layer thickness via the stereo vision system 150, etc.).

In the 3D printer 100 of FIGS. 1A-1H, the example stereo vision system 150 is able to capture images of the layer 601 of build material 605 within approximately 0.1 seconds, discretize the images within about 0.5 seconds, and perform a coarse texture analysis within less than about 1 second. The focused analysis is then selectively applied to flagged regions R_{i,j} 615 or sub-images where the example stereo vision system 150 is used to obtain Z-height measurements at a rate of approximately 80,000 discrete measurements per second. The entire process to image a layer is about 1+(1/80,000)*N seconds where N is the total number of measurement points per layer 601. Stated differently, in many instances, the process time is less than 2 seconds, which does not timewise interfere with the underlying build process. As noted above, this instantation of the 3D printer 100 can perform z-height measurements within at least 6.5 microns when the field of view is about 8″×6″ and within at least 1.4 microns when the field of view is about 2.5″×2″.

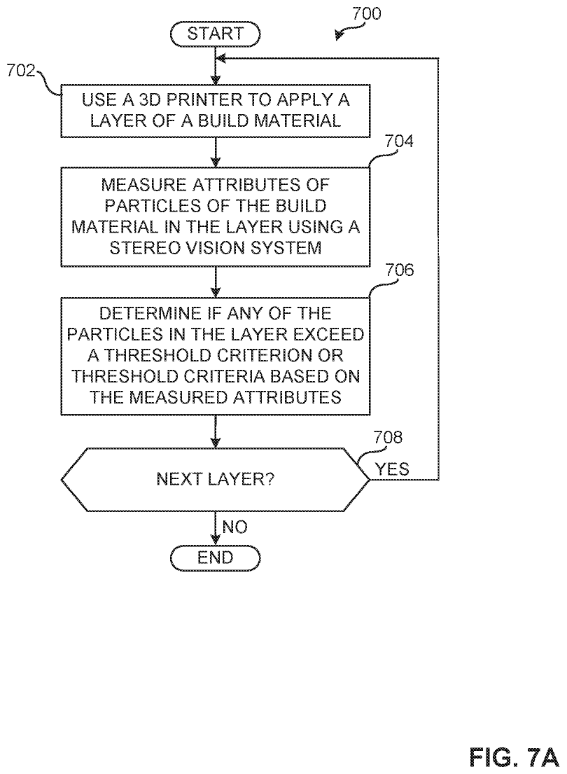

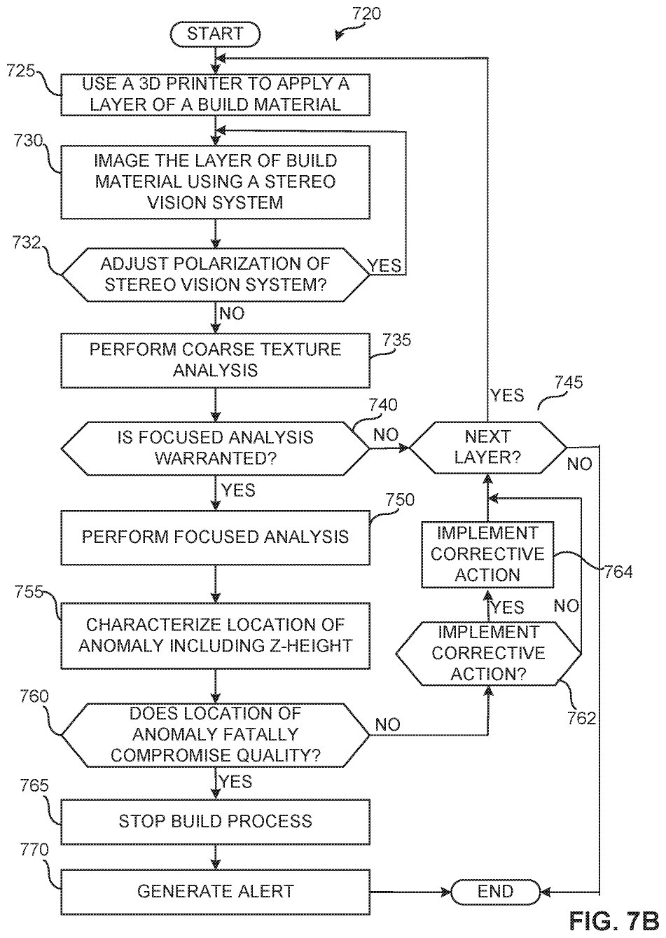

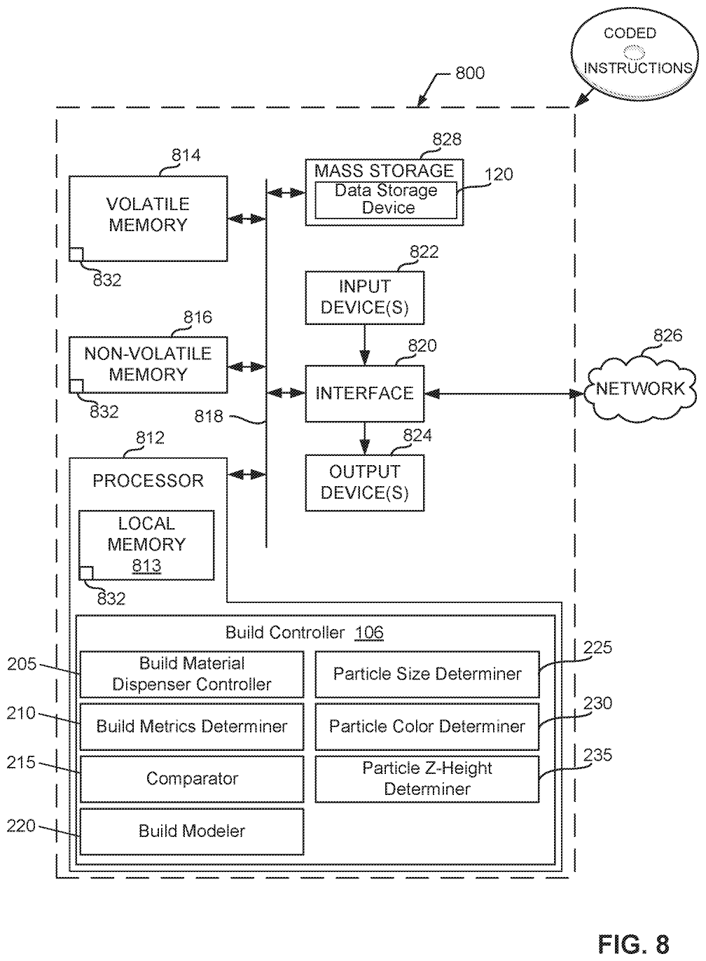

Flowcharts representative of example machine readable instructions for implementing the build controller 106 of FIG. 1 are shown in FIGS. 7A-7B. In these examples, the machine readable instructions comprise a program for execution by a processor such as the processor 812 shown in the example processor platform 800 discussed below in connection with FIG. 8. The programs may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although example programs are described with reference to the flowchart illustrated in FIGS. 7A-7B, many other methods of implementing the example build controller 106 may alternatively be used. For example, the order of execution of the blocks may be changed, and/or some of the blocks described may be changed, eliminated, or combined.

As mentioned above, the example machine readable instructions of FIGS. 7A-7B may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 7A-7B may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended

The example program 700 of FIG. 7A begins with the build controller 106 using the 3D printer 100 to apply a layer of a build material on the build platform 102 (or atop another layer of cured/fused or unfused build material on the build platform) via the build material dispenser controller 205 (block 702). The build controller 106 then measures attributes of particles of the build material in the layer using the stereo vision system 150 and the build metrics determiner 210, the build modeler 220, the particle size determiner 225, the particle color determiner 230 and/or the particular Z-height determiner 235 (block 704). The build controller 106 then determines if any of the particles in the layer exceed a threshold criterion or threshold criteria (e.g., a predetermined particle size, etc.) based on the measured attributes using the comparator 215, alone or in combination with the build metrics determiner 210, the build modeler 220, the particle size determiner 225, the particle color determiner 230 and/or the particular Z-height determiner 235 (block 706). Following the determination of whether any of the particles in the layer exceed a threshold criterion or threshold criteria based on the measured attributes (e.g., a predetermined particle size, etc.), the build controller 106 determines at block 708 whether a next layer of build material is to be applied. If the result of block 708 is “YES,” control passes to block 702. If the result of block 708 is “NO,” the program ends.

The example program 720 of FIG. 7B begins with the build controller 106 using the 3D printer 100 to apply a layer of a build material on the build platform 102 (or atop another layer of cured/fused or unfused build material on the build platform) via the build material dispenser controller 205 (block 725). At block 730, the build controller 106 then causes the stereo vision system 150 to image the build material in the layer and the build modeler 220. At block 732, the build controller 106 determines if it is to adjust a polarization of a light source 166 used to illuminate the layer, a first lens of the first camera 154 of the stereo vision system 150 and a second lens of the second camera 155 of the stereo vision system 150, such as to reduce asymmetric reflections. If, at block 732, the build controller 106 determines that it is to adjust a polarization of the first lens of the first camera 154 and/or the second lens of the second camera 155, the build controller 106 implements the adjustments, such as via the fourth mechanics 134, to configure the stereo vision system 150 to filter reflections impacting identification or analysis of a common feature or common features.

Control then passes to block 735, where the build controller 106 performs a coarse texture analysis on the image data from the stereo vision system 150 using the build modeler 220 to discretize the image data into regions R_{i,j} 615 and to identify therein anomalies that may warrant further analysis. In some examples, the build modeler 220 determines from the stereo vision system 150 image data, or derivatives or discretizations thereof, standard deviations of localized intensity histograms to identify the presence of anomalies in the regions R_{i,j} 615 of the image data. Control then passes to block 740, where the build modeler 220 determines if a focused analysis is warranted. In some examples, the build modeler 220 determines whether the coarse texture analysis indicates the presence of an anomaly in at least one region R_{i,j} 615 of the image data from the stereo vision system 150.

If the result at block 740 is “NO,” control passes to block 745 where the build controller 106 determines whether or not another layer is needed using the build model 104. If the result at block 745 is “YES,” control passes to block 725 where the build controller 106 uses the 3D printer 100 to apply a layer of a build material atop the topmost layer of cured/fused or unfused build material on the build platform via the build material dispenser controller 205. In some examples, prior to application of the next layer, the build controller 106 causes the agent dispenser 124 and/or the energy source 132 to selectively apply an agent and/or to selectively bond or fuse the layer in accord with dictates of the build model 104. If the result at block 745 is “NO,” the program ends.

If the result at block 740 is “YES,” control passes to block 750 where the build controller 106 causes the build modeler 220 to perform a focused analysis on regions R_{i,j} 615 determined to be potentially anomalous during the course texture analysis of block 735. In the focused analysis, the build modeler 220 causes the particle size determiner 225, the particle color determiner 230 and/or the particular Z-height determiner 235 to accurately locate the anomaly or anomalies within each region R_{i,j} 615 of the image data using image processing techniques such as, but not limited to, edge detection, thresholding and/or blob detection. Control then passes to block 755.

At block 755, the build modeler 220 causes the particle size determiner 225, the particle color determiner 230 and/or the particular Z-height determiner 235 to characterize a location of the anomaly or anomalies (e.g., an anomalous particle, etc.) including a Z-height location. At block 755, the build modeler 220 also correlates the (X,Y) position of each anomaly within the build volume on a layer-by-layer basis and maps the position (X,Y,Z) of each anomalous particle in each layer.

At block 760, the build modeler 220 determines whether the location (X,Y,Z) of each anomaly and/or characteristics of each anomaly itself, or in combination with locations (X,Y,Z) and/or characteristics of other anomalies causes the layer (e.g., 601) and/or the 3D object 101 to fail to satisfy a quality threshold. At block 760, the build modeler 220 also determines whether any anomaly or anomalies, singly or in combination, are rectifiable via processing and/or post-processing or, instead, are fatal to the quality of the 3D object 101, requiring rejection of the 3D object 101. If the result at block 760 is “YES,” control passes to block 765 where the build controller 106 stops the build process for the 3D object 101 and to block 770 where the build controller 106 generates an alert, such as via the interface 135, prior to ending the build process.

If the result at block 760 is “NO,” control passes to block 762 where the build controller 106 determines whether or not to implement a corrective action in view of the build model 104. If the result at block 762 is “YES,” control passes to block 764 where a corrective action is implemented by the build controller 106. In some examples, the corrective action may include a change to a fusing agent applied via the agent dispenser 124, a change to an applied layer thickness via the build material dispenser 110, and/or a change to an application of energy via energy source 132. If the result at block 762 is “NO,” control passes to block 745 where the build controller 106 determines whether or not another layer is needed using the build model 104.

FIG. 8 is a block diagram of an example processor platform 800 capable of executing the instructions of FIGS. 7A-7B to implement the build controller 106 of FIG. 2. The processor platform 800 can be, for example, a server, a personal computer, a mobile device (e.g., a cell phone, a smart phone, a tablet such as an iPad™), a personal digital assistant (PDA), an Internet appliance or any other type of computing device.

The processor platform 800 of the illustrated example includes a processor 812. The processor 812 of the illustrated example is hardware. For example, the processor 812 can be implemented by integrated circuits, logic circuits, microprocessors and/or controllers from any desired family or manufacturer. In the illustrated example, the processor 812 implements the example build material dispenser controller 205, the example build controller 106, the example comparator 215, the example build modeler 220, the example particle size determiner 225, the example particle color determiner 230 the example particle z-height determiner 235 and/or more generally the build controller 106.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, an input device(s) 822 is connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

An output device(s) 824 is also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes a mass storage device(s) 828 for storing software and/or data. Examples of such mass storage devices 828 include floppy disk drives, hard drive disks, compact disk drives, Blu-ray disk drives, RAID systems, and digital versatile disk (DVD) drives. In the illustrated example, the mass storage device(s) 828 implements the data storage device 120.

The coded instructions 832 of FIGS. 7A-7B may be stored in the mass storage device 828, in the volatile memory 814, in the non-volatile memory 816, and/or on a removable tangible computer readable storage medium such as a CD or DVD.

From the foregoing, it will be appreciated that the above disclosed methods, apparatus, systems and articles of manufacture relate to three-dimensional (3D) printers that generate 3D objects 101 through an additive construction process guided by build models 104. In some examples, attributes of particles of the build material are measured using a stereo vision system and the image data from the stereo vision system is used to determine if a particle in a layer of the build exceeds a threshold criterion or threshold criteria based on the measured attributes, such as a predetermined particle size and/or a Z-height of the particle. In some examples, the measured attributes include the lateral location (X,Y), from which it can be determined whether the particle lies in a critical build structure or is merely disposed in a non-critical area. In some examples, corrective actions for the top-most layer of the build material are conditioned on the Z-height of the particle, with a first corrective action being taken for a first range of Z-heights (e.g., a sub-elevated particle) and a second corrective action being taken for a second range of Z-heights (e.g., a super-elevated particle).

The above-disclosed methods, apparatus, systems and articles of manufacture yield a significant improvement in resolution (e.g., within 1.4 microns) or greater than about 10×. At these resolutions, the image data may inform process enhancements previously unrealized. For instance, the above-disclosed methods, apparatus, systems and articles of manufacture may be used to determine changes in particle size and/or changes in particle size distribution run-to-run to determine aging effects of the build material (e.g., build material including recycled build material from prior runs, etc.) and then effect a correct timing for build material replacement or renewal in response to the run-to-run changes in particle size and/or changes in particle size distribution. As an additional example, the above-disclosed methods, apparatus, systems and articles of manufacture may be used to discern a spatial distribution of particle sizes by analyzing the quality/amount of trackable texture within regions R_{i,j} used for stereoscopic depth extraction wherein small sub-regions of the regions R_{i,j} are used for correlation. The quality/amount of trackable texture within each subset will be proportional to the number of particles that are resolved by the stereo vision system 150. Since the stereo vision system 150 has a fixed spatial resolution, the percentage of particles that are sized above/below the resolution threshold in the field of view (e.g., a selected region R_{i,j}) can be ascertained.

In some examples, multiple stereo vision systems 150 can be used to, for example, provide a plurality of different spatial resolutions. In some examples, the different spatial resolutions can be used to digitally sieve the build material. This approach provides a unique spatial measure of particle size distribution that, when combined with x, y, z data from the stereo vision technique, can be leveraged to extract additional spatially resolved powder metrics (e.g. powder packing density).

While examples herein relate to an anomaly including a large particle (e.g., second anomaly 630), the disclosure is not limited to large particles and instead includes all particles that are outside of an acceptable size and/or shape, as well as distributions of build material (e.g., a distribution of build material within a layer, a distribution of build material between adjacent layers, a distribution of build material within a 3D object 101, a run-to-run distribution of build material for one or more layers, etc.). Further, in some examples, the sensor 113 includes an array of microelectromechanical system (MEMS) cameras (e.g., flat panel camera arrays, etc.) in lieu of the example stereo vision system 150.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method, comprising:
using a 3D printer to apply a layer of a build material;
measuring attributes of the build material in the layer using a stereo vision system; and
determining if the build material in the layer exceeds a threshold criterion based on the measured attributes.

2. The method of claim 1, wherein the attributes include a build material particle size and wherein the threshold criteria includes a predetermined particle size.

3. The method of claim 2, wherein the attributes include location information for particles determined to reside within a portion of a 3D object being printed and determined to exceed the threshold criterion.

4. The method of claim 3, wherein the location information includes (X,Y) location and a Z-height of particles exceeding the threshold criterion.

5. The method of claim 4, further including mapping a location of the particles exceeding the threshold criterion using the location information.

6. The method of claim 4, further including measuring a spatial distribution of particle sizes or measuring a trackable texture of the particles.

7. The method of claim 6, further including extracting spatially resolved powder metrics using the location information and spatial distribution of particle sizes.

8. The method of claim 4, further including cross polarizing a light source used to illuminate the layer, a first lens of a first camera of the stereo vision system and a second lens of a second camera of the stereo vision system to reduce asymmetric reflections.

9. The method of claim 8, further including adjusting the first lens and the second lens of the stereo vision system to filter reflections adversely impacting identification of a common feature.

10. The method of claim 3, wherein the measuring of attributes of particles of the build material includes performing a coarse texture analysis and performing a focused analysis on portions of the layer determined by the coarse texture analysis to have an anomaly exceeding the threshold criterion.

11. A method, comprising:
forming a layer of build material on a build platform of a 3D printer; and
correlating X-Y position data and stereoscopic Z-height data for particles of the build material in the layer of build material that are determined to exceed a threshold criterion based on a measure attribute.

12. The method of claim 11, wherein the stereoscopic Z-height data is obtained using a stereo vision system including a first camera and a second camera aligned to image the particles of the build material in the layer of build material, and wherein the threshold criterion includes at least one of a predetermined particle size and a predetermined particle location relative to a 3D object being printed.

13. The method of claim 12, wherein the measuring of attributes of particles of the build material includes performing a coarse texture analysis and performing a focused analysis on portions of the layer determined by the coarse texture analysis to have an anomaly exceeding the threshold criterion.

14. A 3D printer, comprising:
a build controller to measure, via a stereo vision system, an attribute of a particle of build material in a layer of build material;
a build modeler to build a 3D object on the 3D printer, via the build controller, in accord with a build model; and
a comparator to compare the attribute of the particle to threshold criterion for the measured attribute.

15. The 3D printer of claim 14, wherein the attribute includes a size of the particle of build material or a Z-height of the particle of build material.
